(19) United States
(12) Patent Application Publication
(10) Pub. No.: US 2024/0086685 A1
(43) Pub. Date: Mar. 14, 2024

(54) METHOD, APPARATUS, DEVICE AND STORAGE MEDIUM FOR RECOMMENDING INFORMATION

(71) Applicants: Beijing Youzhuju Network Technology Co., Ltd., Beijing (CN); Lemon Inc., Grand Cayman (KY)

(72) Inventors: Xiaosong ZHOU, Beijing (CN); Qingliang CAI, Beijing (CN); Shu CHEN, Beijing (CN); Zhe WANG, Los Angeles, CA (US); Haiqian HE, Singapore (SG)

(21) Appl. No.: 18/463,389

(22) Filed: Sep. 8, 2023

(30) Foreign Application Priority Data
Sep. 8, 2022 (CN) 202211097431.5

(51) Int. Cl. G06N 3/0464

(52) U.S. Cl. CPC G06N 3/0464

(57) ABSTRACT

A method, apparatus, device and storage medium for recommending information. The method includes determining, based on a set of feature representations of a plurality of features associated with information recommendation, a first set of weights indicating importance of the plurality of features. The method also includes determining a second set of weights based on the set of feature representations and the first set of weights. The method further includes recommending the information to a user based on the set of feature representations, the first set of weights and the second set of weights. The importance of respective features associated with the information recommendation can be accurately determined through this method, which further improves the effectiveness of information recommendation and improves the user experience.

### CROSS REFERENCE TO RELATED APPLICATIONS

This application claims priority of the Chinese invention patent application with the application number 202211097431.5, entitled “METHOD, APPARATUS, DEVICE AND STORAGE MEDIUM FOR RECOMMENDING INFORMATION”, and filed on Sep. 8, 2022, the entire contents of those applications being incorporated herein by reference in their entirety.

### FIELD

Embodiments of the present disclosure generally relate to the field of computers, and more specifically, to method, apparatus, device and storage medium for recommending information.

### BACKGROUND

With the development of computer technology and network technology, more and more users begin to acquire various information from the network via computers. Some information is first searched by users, then recommended by the network and finally received by the users, while some is directly recommended to the users by the computing device in the network. As the information recommendation technology advances, more and more applications are provided with functions for recommending information to the users, so as to provide better service. However, there are still many problems to be addressed in the process of recommending information for users.

### SUMMARY

Embodiments of the present disclosure provide a method, apparatus, device and storage medium for recommending information.

In accordance with a first aspect of the present disclosure, there is provided a method for recommending information. The method comprises determining, based on a set of feature representations of a plurality of features associated with information recommendation, a first set of weights indicating importance of the plurality of features. The method also comprises determining a second set of weights based on the set of feature representations and the first set of weights. The method further comprises recommending the information to a user based on the set of feature representations, the first set of weights and the second set of weights.

In accordance with a second aspect of the present disclosure, there is provided an apparatus for recommending information. The apparatus comprises a first set of weights determination module configured to determine, based on a set of feature representations of a plurality of features associated with information recommendation, a first set of weights indicating importance of the plurality of features; a second set of weights determination configured to determine a second set of weights based on the set of feature representations and the first set of weights; and a recommendation module configured to recommend the information to a user based on the set of feature representations, the first set of weights and the second set of weights.

In accordance with a third aspect of the present disclosure, there is provided an electronic device, comprising at least one processor; and a storage device for storing at least one program which, when executed by the at least one processor, causes the at least one processor to implement the method according to the first aspect.

In accordance with a fourth aspect of the present disclosure, there is provided a computer-readable storage medium having computer programs stored thereon which, when executed by a processor, implement the method according to the first aspect.

It should be appreciated that the contents described in this Summary are not intended to identify key or essential features of the embodiments of the present disclosure, or limit the scope of the present disclosure. Other features of the present disclosure will be understood more easily through the following description.

### BRIEF DESCRIPTION OF THE DRAWINGS

Through the following detailed description of the example embodiments of the present disclosure with reference to the accompanying drawings, the above and other objectives, features, and advantages of the present disclosure will become more apparent. In the example embodiments of the present disclosure, the same reference sign usually indicates the same component.

FIG. 1 illustrates a schematic diagram of an example environment in which a device and/or method according to embodiments of the present disclosure may be implemented;

FIG. 2 illustrates a schematic diagram of an example of modifying feature representations according to embodiments of the present disclosure;

FIG. 3 illustrates a schematic diagram of a method for recommending information according to embodiments of the present disclosure;

FIG. 4 illustrates a schematic diagram of an example for modifying feature representations according to embodiments of the present disclosure;

FIG. 5 illustrates a schematic diagram of an example for modifying feature representations according to embodiments of the present disclosure;

FIG. 6 illustrates a schematic block diagram of an apparatus for recommending information according to embodiments of the present disclosure;

FIG. 7 illustrates a schematic diagram of example devices suitable for implementing embodiments of the present disclosure.

In each drawing, same or corresponding reference sign indicates the same or corresponding component.

### DETAILED DESCRIPTION OF EMBODIMENTS

It is to be understood that users should be informed of types, application ranges and usage scenarios of their personal information involved in the present disclosure through suitable ways in accordance with the relevant laws and regulations and the use of the personal information should be authorized by the users before the application of the technical solutions disclosed in various embodiments of the present disclosure.

For example, in response to receiving an active request from the users, a prompt message is sent to the users to clearly indicate the users that the operation to be executed by the request needs to obtain and use their personal information. Therefore, the users may voluntarily select, in accordance with the prompt message, whether to provide their personal information to electronic devices, application programs, servers or storage media among other software or hardware executing operations included in the technical solutions of the present disclosure.

As an alternative and non-restrictive implementation, in response to receiving an active request from the users, a prompt message is sent to the users for example in a pop-up window. The prompt message may be displayed in text in the pop-up window. In addition, the pop-up window may also be provided with a selection control, through which the user may choose to “agree” or “disagree” the provision of the personal information to the electronic device.

It should be appreciated that the above process of informing the users and obtaining the authorization from the users is only exemplary and does not limit the implementations of the present disclosure. Other approaches in compliance with the relevant laws and regulations may also be applied into the implementations of the present disclosure.

It is to be understood that data involved in the technical solutions of the present disclosure, including but not limited to data per se, and the acquisition or use of the data, should follow requirements of corresponding laws, regulations and rules. In response to receiving an active request from the users, a prompt message is sent to the users to clearly indicate the users that the operation to be executed by the request needs to obtain and use their personal information. Therefore, the users may voluntarily select, in accordance with the prompt message, whether to provide their personal information to electronic devices, application programs, servers or storage media among other software or hardware executing operations included in the technical solutions of the present disclosure.

Embodiments of the present disclosure will be described below in more details with reference to the drawings. Although the drawings illustrate some embodiments of the present disclosure, it should be appreciated that the present disclosure can be implemented in various manners and should not be limited to the embodiments disclosed herein. On the contrary, the embodiments are provided for a more thorough and complete understanding of the present disclosure. It is to be understood that the drawings and the embodiments of the present disclosure are provided merely for the exemplary purpose, rather than restricting the protection scope of the present disclosure.

In the description of the embodiments of the present disclosure, the term “includes” and its variants are to be read as open-ended terms that mean “includes, but is not limited to.” The term “based on” is to be read as “based at least in part on.” The terms “one embodiment” and “this embodiment” are to be read as “at least one example embodiment.” The terms “first”, “second” and so on can refer to same of different objects. The following text also may include other explicit and implicit definitions.

As stated above, there are many problems to be solved when the information is recommended to users. For example, when recommending information for users, in addition to selecting a good information recommendation model, it is also necessary to achieve accurate recommendation based on a large amount of features related to the information recommendation. These features, for example, are associated with the information to be recommended or the user. As the information recommendation system develops, more features need to be input. However, some features are of higher importance for the user to make a determination as to whether to accept the recommended information, while some are not. If all of the features are processed in the same way, then as the number of features increases, the information recommendation system is unable to obtain the key information. This further impacts the recommendation effect.

To address the above problems, some traditional solutions rely on the staff knowing background knowledge to raise and lower the importance of a feature. For example, some features are assigned with a higher importance while some are given a lower importance. However, in the traditional solutions, the importance of the feature is determined manually by personnel with higher professional background knowledge. As such, these traditional solutions can hardly be promoted and used wildly. Even though the importance can be manually set, the importance of the feature may not be accurately determined as the information recommendation system is not really a white-box technical solution.

To at least solve the above and other potential problems, embodiments of the present disclosure provide a method for recommending information. In this method, a computing device determines a first set of weights associated with feature importance using a set of feature representations of a plurality of features related to information recommendation. The computing device then obtains a second set of weights based on the set of feature representations and the first set of weights. Next, the computing device recommends the information to a user in accordance with the set of feature representations, the first set of weights and the second set of weights. The importance of each feature related to the information recommendation can be more accurately determined through this method, to recommend the information more effectively and improve user experience.

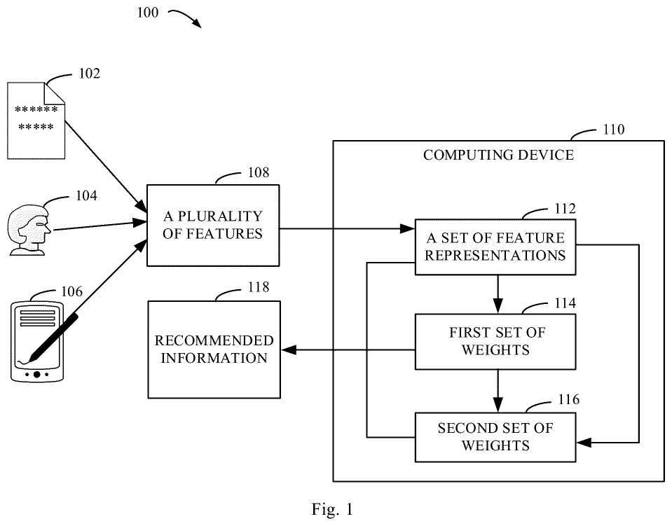

Embodiments of the present disclosure are further described in details below with reference to the drawings, wherein FIG. 1 illustrates an example environment in which the device and/or method according to the embodiments of the present disclosure can be implemented.

There is a computing device 110 in the environment 100. The computing device 110 determines information 118 recommended to a user through a set of feature representations 112 of a plurality of features 108 associated with the information recommendation.

Example of the computing device 110 includes, but not limited to, a personal computer, a server computer, a handheld or laptop device, a mobile device (e.g., a mobile phone, a Personal Digital Assistant (PDA), a media player and the like), a multi-processor system, consumer electronics, a minicomputer, a mainframe computer, distributed computing environment including any of the above systems or devices and the like.

The environment 100 also includes a plurality of features 108 associated with information recommendation. The plurality of features 108 is used by the information recommendation system to recommend information to a user. As shown in FIG. 1, the plurality of features 108 is obtained from information 102 to be recommended, a user 104 and a terminal device 106 used by the user, such as an identification of the user 104, behavior statistics of the user 104, identification of the information 102, attributes of the information 102, traffic attributes and attributes of the device 106 etc. As illustrated in FIG. 1, a plurality of features includes features from the information 102, the user 104 and the terminal device 106 used by the user. This is just an example and should not be interpreted as a specific limitation on the present disclosure. The plurality of features may be one or more of the features including: features of the information, features of the user to whom the information is to be recommended and features of the computing device or related network devices utilized by the user. Alternatively or additionally, the plurality of features also may include a variety of suitable features configured by those skilled in the art as required.

The computing device 110 receives a set of feature representations 112 of the plurality of features 108, wherein each feature has one representation. For example, the feature representation of each feature is a 16-dimensional vector. In such case, the set of feature representations is a vector having 100*16 dimensions if the plurality of features 108 includes 100 features.

The computing device 110 determines a first set of weights 114 based on the set of feature representations 112. Each value in the first set of weights 114 indicates the importance of one feature. For example, when there are 100 features, 100 weights are determined by 100 feature representations, i.e., each feature has a corresponding weight, also known as importance. For example, a set of weights may be determined by a Logistic Regression (LR) model. The Logistic Regression model is trained based on the sample feature representations and the sample importance. Alternatively or additionally, the weight ranges from 0 to 1. In this way, the importance of the feature can be determined quickly and accurately.

After obtaining the first set of weights 114, the computing device 110 determines a second set of weights 116 based on the set of feature representations 112 and the first set of weights 114. The second set of weights includes weight corresponding to each of the plurality of features. Afterwards, the computing device 110 modifies a set of feature representations 112 based on the set of feature representations 112, the first set of weights 114 and the second set of weights 116 and further determines the recommended information 118 with the modified set of feature representations.

In this way, the importance of respective features associated with the information recommendation can be more accurately determined, so as to more effectively recommend the information and improve user experience.

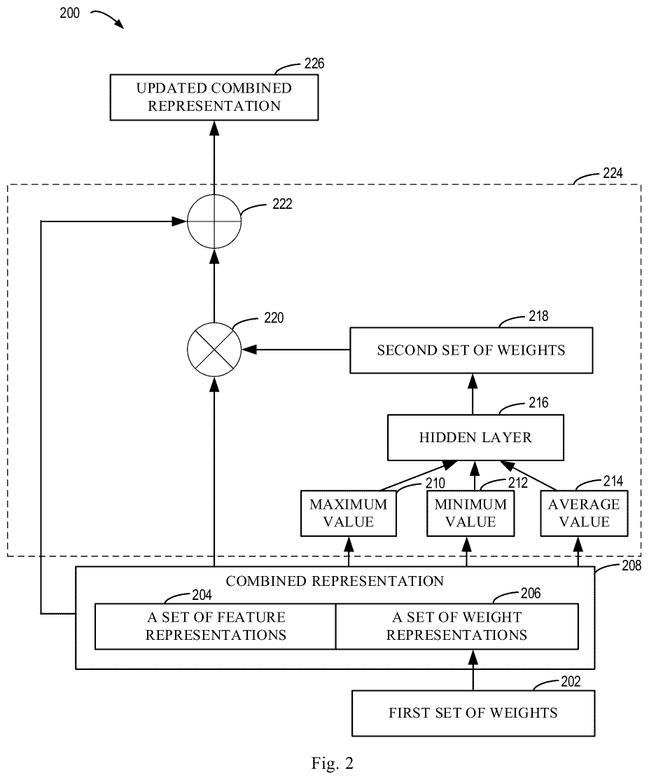

The example environment in which the device and/or method according to the embodiments of the present disclosure can be implemented has been depicted above with reference to FIG. 1. Then, a schematic diagram of an example of modifying feature representations according to embodiments of the present disclosure is to be described below with reference to FIG. 2.

In the example 200, the computing device 110 first determines a first set of weights 202 corresponding to a plurality of features associated with information recommendation. In one example, the first set of weights 202 is obtained via the logistic regression model in accordance with the feature representation of each feature. In another example, the first set of weights 202 is obtained from a mapping relation between the feature representation of each feature and the weight. The above example is provided only for describing the present disclosure rather than limitation. Those skilled in the art may configure as required an implementation in which the weight is obtained based on the feature representation. Then, the computing device 110 converts the first set of weights 202 into a set of weight representations 206. The set of weight representations are combined with a set of feature representations 204 to generate a combined representation 208. The combined representation 208 is subsequently input to a representation modification module 224 for modifications.

As shown in FIG. 2, the combined representation 208 is modified in the representation modification module 224. For each representation in the combined representation, a maximum value, a minimum value and an average value of representation components of each representation are used as the representation information of each representation. For example, when there are 100 features and each feature has a 16-dimensional vector, the maximum value, minimum value and average value are determined from the 16-dimensional vector for each feature. These three values may replace the 16-dimensional vector and further act as the modified feature representation of each feature. At this moment, each modified feature representation is a three dimensional vector. The maximum value, minimum value and average value are also determined for each weight representation in the combined representation as new weight representation. For example, if there are 100 weights corresponding to 100 features and every ten weights form a weight representation, a vector having 10*3 dimensions is formed after the modification. In this case, the combined representation is a vector having 110*3 dimensions.

The maximum value 210, the minimum value 212 and the average value 214 are then input to a hidden layer 216, to acquire a second set of weights 218. The hidden layer 216 may be implemented by a neural network. The hidden layer may be implemented by a convolutional neural network or a fully connected neural network. The second set of weights 218 is the output of the hidden layer. For example, the hidden layer may generate weights corresponding to each representation in the combined representation, e.g., the weights having 110 dimensions. Alternatively or additionally, a mapping relation table may substitute the hidden layer 216, and the second set of weights 218 corresponding to the modified combined representation is determined based on the mapping relation table. The above example is illustrated only for describing the present disclosure rather than limitation.

Each weight in the second set of weights 218 multiply a corresponding representation in the combined representation 208 at 220 to produce a weighted combined representation. The weighted combined representation is then added to the combined representation 208 at 222 to generate an updated combined representation 226 for recommending information to the user. Alternatively or additionally, some neural network models are then connected subsequent to the updated combined representation 226 and further utilized to process the updated combined representation, so as to determine the recommended information.

In this way, the importance of respective features associated with the information recommendation can be accurately determined, so as to more effectively recommend the information and improve user experience.

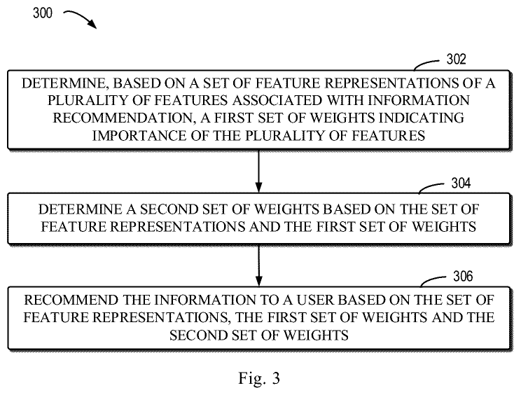

The schematic diagram of an example of modifying feature representations according to embodiments of the present disclosure has been depicted above with reference to FIG. 2. Next, a schematic diagram of a method 300 for recommending information according to embodiments of the present disclosure is to be described below with reference to FIG. 3. The method shown by FIG. 3 can be executed on the computing device 110 illustrated in FIG. 1 or any suitable computing devices.

At block 302, a first set of weights indicating importance of a plurality of features is determined based on a set of feature representations of the plurality of features associated with information recommendation. As illustrated in FIG. 1, the computing device 110 will obtain a set of feature representations 112 of a plurality of features 108 associated with the information recommendation.

In some embodiments, a plurality of features includes at least one of: a user identification, user behavior statistics, an information identification, information attributes, traffic attributes and device attributes. For example, one or more of the features of the user 104, the features of the information 102 and the features of the device 106 or the network may be used as the feature in the plurality of features 108. Accordingly, the relevant feature information may be rapidly obtained and the efficiency of feature acquisition is also improved.

At 304, a second set of weights is determined based on the set of feature representations and the first set of weights. As shown in FIG. 1, the computing device 110 obtains the second set of weights based on the set of feature representations 112 and the first set of weights 114. FIG. 2 illustrates a specific example of obtaining the second set of weights on the basis of the set of feature representations and the first set of weights.

In some embodiments, the computing device generates a set of weight representations by dividing the first set of weights into a plurality of subsets, where each subset forms a weight representation. For example, if there are 100 weights related to 100 features, a weight representation may be generated from every 10 weights. As a result, 10 weight representations are formed and each weight representation is a 10-dimensional vector. Afterwards, the combined representation is generated by combining a set of weight representations with a set of feature representations. Next, the computing device 110 determines the second set of weights based on the combined representation. In some embodiments, the first set of weights may directly act as a set of weight representations to combine with the set of feature representations. In one example, each weight represents a weight representation. In a further example, the first set of weights 202 as a whole is used as a weight representation. In this way, the second set of weights can be rapidly and accurately determined based on the feature representation and more information. The above example is provided only for describing the present disclosure rather than limitation.

In some embodiments, when the second set of weights is determined based on the combined representation, the computing device 110 modifies the combined representation to generate the modified combined representation. A second set of weights is then determined based on the modified combined representation. In one example, during the modification of the combined representation, a plurality of components of each representation in the combined representation is determined firstly. For each representation, at least one of a maximum value or a minimum value among a plurality of components or an average value of a plurality of components is determined for each representation. The modified combined representation is generated on the basis of the at least one of the above values. In the example shown by FIG. 2, each representation is modified using its maximum value, minimum value and average value. Afterwards, the modified combined representation is formed from each representation. The second set of weights is then generated using a hidden layer. In this way, the amount of data to be processed may be reduced and the data processing procedure is accelerated.

In another example, during the modification of the combined representation, the computing device 110 generates a modified combined representation by applying the neural network model into the combined representation. Accordingly, the combined representation may be determined rapidly and accurately. In a further example, during the modification of the combined representation, the computing device groups representations in the combined representation to generate a plurality of groups of representations. For example, 110 representations including 100 feature representations and 10 weight representations are grouped. Each group includes 10 representations and a total of 11 groups are formed in the end. Afterwards, the statistic values of each of the plurality of groups of representations are determined. For example, an average value and a value of difference of square among other statistical values in each group of representations are calculated. Each group of representations is substituted by their statistical values and these groups are combined to generate the modified combined representation. Therefore, the amount of data information to be processed may be reduced and the data processing procedure is accelerated.

In some embodiments, while determining the second set of weights based on the modified combined representation, the computing device 110 compresses the modified combined representation to generate a compressed combined representation. The compressed combined representation is then modified to generate the second set of weights. As shown in FIG. 2, the computing device 110 implements this process by means of two layers of network of the hidden layer. For example, subsequent to the modification based on the maximum value, the minimum value and the average value, if the combined representation has 110 features, the input of the hidden layer has 110*3 dimensions and the first layer of network of the hidden layer may be a fully connected network (having a dimension of 330*64). As the second set of weights 218 is provided for 110 representations, the second layer of network may be a fully connected network (having a dimension of 64*110).

At block 306, the information is recommended to a user based on the set of feature representations, the first set of weights and the second sets of weights. As shown in FIG. 1, the computing device 110 recommends information to the user in accordance with the set of feature representations 112, the first set of weights 114 and the second sets of weights 116.

In some implementations, while modifying a set of feature representations, the computing device 110 generates the weighted combined representation by applying the second set of weights to the combined representation 208 as shown in FIG. 2. In this way, the importance of each representation in the combined representation can be modified accurately and rapidly. Alternatively or additionally, SENet (Squeeze-and-Excitation Networks) may implement the modification of the combined representation, the determination of the second set of weights and the generation of the weighted combined representation by applying the second set of weights to the combined representation.

Moreover, the computing device generates an updated combined representation by combining the weighted combined representation with the combined representation and subsequently recommends the information to the user via the updated combined representation. As such, the combined representation is accurately modified and the information can be recommended correctly. Alternatively or additionally, the generation of the updated combined representation by combining the weighted combined representation with the combined representation may be fulfilled by Residual Network (ResNet).

In some embodiments, the computing device determines, based on the updated combined representation, a probability that the information is accepted by the user. The information is recommended to the user only when the probability exceeds a threshold probability; otherwise, the information will not be recommended.

In some embodiments, the determination of the second set of weights, the generation of the weighted combined representation and the combination of the weighted combined representation and the combined representation are fulfilled by the neural network model, e.g., a neural network model formed from the combination of SENet and ResNet. As shown in FIG. 2, the representation modification module 224 may be implemented by a neural network model formed by combining SENet with ResNet. In one example, the computing device 110 also may train this neural network model together with a subsequent neural network model that recommends the information to the user based on the updated combined representation. The computing device 110 trains a combined neural network model based on a set of sample feature representations of a plurality of features corresponding to the sample information recommendation and a sample result of the sample information selected by the user. Accordingly, the neural network model can be quickly obtained. In some embodiments, the computing device 110 obtains the trained neural network model from other computing devices.

The importance of respective features associated with the information recommendation can be more accurately determined by this method, thereby enhancing the effectiveness of the information recommendation and improving user experience.

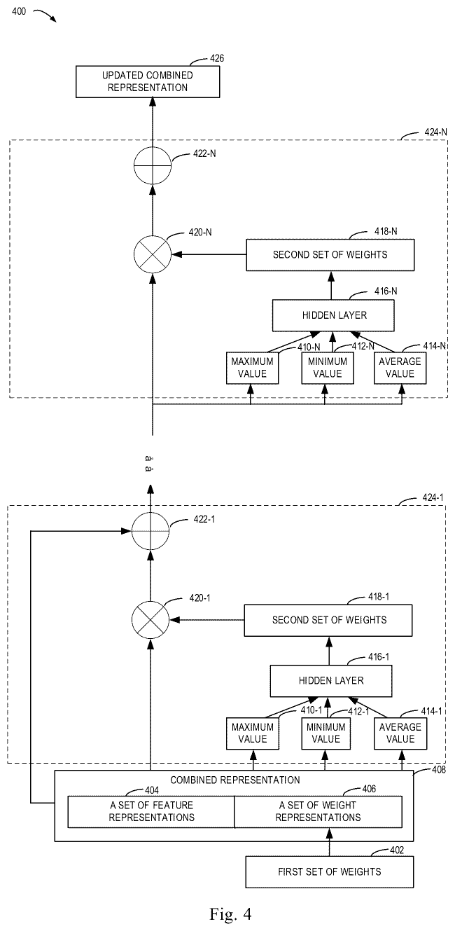

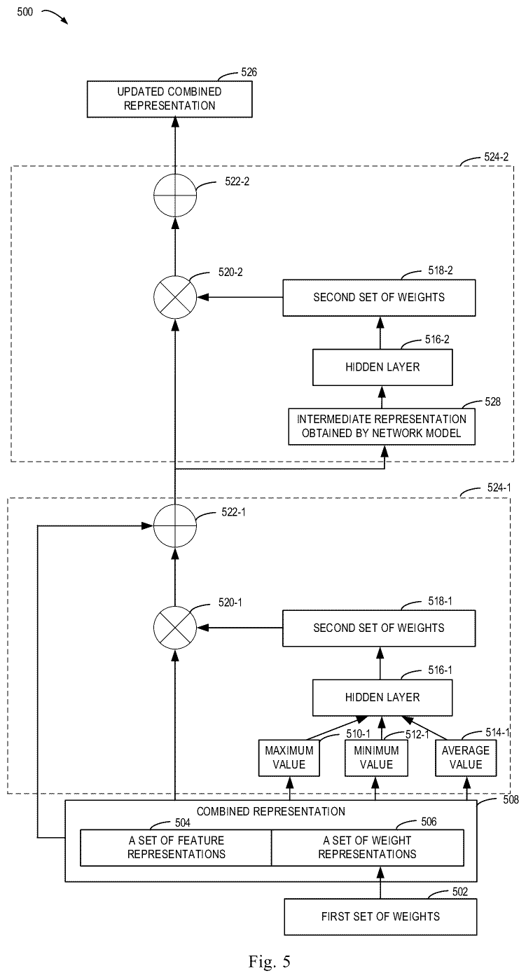

The schematic diagram of the method for recommending information in accordance with the embodiments of the present disclosure has been depicted above with reference to FIG. 3. Next, two examples for modifying the feature representation in accordance with embodiments of the present disclosure are to be described below with reference to FIGS. 4 and 5.

As shown in FIG. 4, a set of weight representations 406, which is generated from a first set of weights 402, is combined with a set of feature representations 404 to generate a combined representation 408. The combined representation 408 is then input into a plurality of connected representation modification modules 424-1, . . . , 424-N for modifying the combined representation, so as to generate an updated combined representation 426, where N is a positive integer. The acts executed in the representation modification modules 424-1, . . . , 424-N are identical to those performed in the representation modification module 224 shown in FIG. 2. For example, a maximum value 410-1, a minimum value 412-1 and an average value 414-1 are determined in the representation modification module 424-1. The second set of weights 418-1 is then generated via the hidden layer 416-1 and further multiplied with the combined representation 408 at 420-1. The weighted combined representation is added with the combined representation at the operation 422-1 as an output of the representation modification module 424-1. A maximum value 410-N, minimum values 412-N and average value 414-N are determined in the representation modification module 424-N. A second set of weights 418-N is then generated via a hidden layer 416-N. A multiplication operation is further performed between the second set of weights 418-N and the output of the representation modification module 424-1 at 420-N. Next, the weighted output of representation modification modules is added with the output of the representation modification modules 424-1 at the operation 422-N as the output of the representation modification module 424-N, so as to generate an updated combined representation 426. In FIG. 4, the combined representation before being input into the hidden layer is modified in the same way within the respective modification modules, i.e., the maximum value, the minimum value and the average value of the combined representation are obtained.

In some embodiments, before being input into the hidden layer, the combined representation is modified in different ways in the respective modification modules. For example, the computing device further obtains the updated combined representation modified by modifying the updated combined representation, and subsequently determines a third set of weights for the updated combined representation on the basis of the updated combined representation modified. Next, the computing device generates the updated combined representation weighted in accordance with the updated combined representation and the third set of weights. However, the updated combined representation is modified in a way different from the combined representation. Accordingly, the data is processed by different modification approaches to obtain a more accurate result. The different modification approaches are illustrated in FIG. 5. Specifically, FIG. 5 shows a procedure of data processing via different modification approaches. In this example, before being input to the hidden layer, the combined representation is modified in different ways within respective modification modules.

As shown in FIG. 5, a set of weight representations 506 is generated by a first set of weights 502 and combined with a set of feature representations 504 to produce a combined representation 508. The combined representation 508 is then input to two connected representation modification modules 524-1 and 524-2 for modifying the combined representation 508. In the modification module 524-1, a maximum value 510-1, a minimum value 512-1 and an average value 514-1 are determined for each representation of the combined representation 508. A second set of weights 518-1 is then determined using the hidden layer 516-1. The second set of weights 518-1 and the combined representation multiply at 520-1 to obtain a weighted combined representation. The weighted combined representation is added with the combined representation at 522-1 to act as the output of the representation modification module 524-1. The output of the representation modification module 524-1 is input to the representation modification module 524-2. When the output of the representation modification module 524-1 is being modified at the representation modification module 524-2, an intermediate representation is obtained at block 528 via a network model. The intermediate representation is input to the hidden layer 516-2 to obtain a second weight representation 518-2. The second weight representation 518-2 and the output of the representation modification module 524-1 multiply at 520-2. The weighted output of the representation modification module 524-1 is added with the output of the representation modification module 524-1 to produce an updated combined representation 526. FIG. 5 shows two representation modification modules 524-1 and 524-2, both of which are provided as examples only rather than limitation. The example also may include a plurality of representation modification modules, each of which may adopt a combined representation modification manner same as or different from other modules.

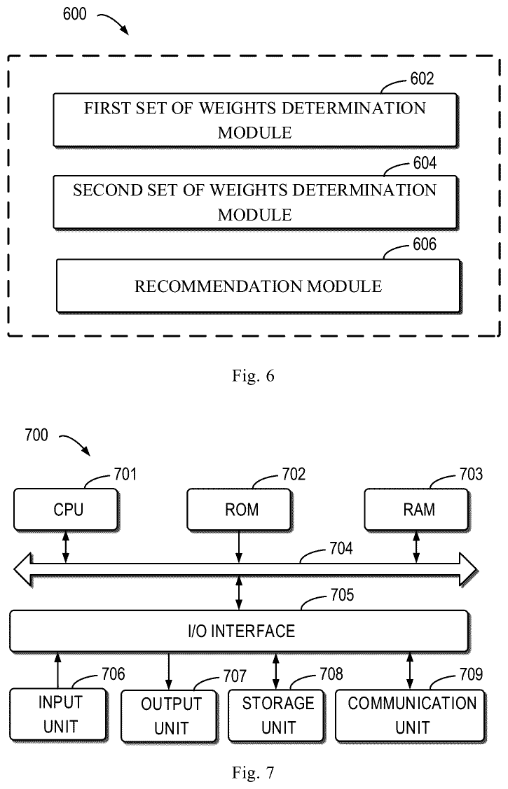

FIG. 6 illustrates a schematic block diagram of an apparatus for recommending information in accordance with embodiments of the present disclosure. As shown in FIG. 6, an apparatus 600 includes a first set of weights determination module 602 configured to determine, based on a set of feature representations of a plurality of features associated with information recommendation, a first set of weights indicating importance of the plurality of features; a second set of weights determination module 604 configured to determine a second set of weights based on the set of feature representations and the first set of weights; and a recommendation module 606 configured to recommend the information to the user based on the set of feature representations, the first set of weights and the second set of weights.

In some embodiments, the first set of weights determination module 602 includes: a logistic regression model application module configured to obtain the first set of weights by applying a logistic regression model to a set of feature representations.

In some embodiments, the plurality of features includes at least one of: a user identification, user behavior statistics, an information identification, information attributes, traffic attributes and device attributes.

In some embodiments, the second set of weights determination module 604 includes: a weight dividing module configured to generate a set of weight representations by dividing the first set of weights into a plurality of subsets, each subset forming a weight representation; a representation combination module configured to generate a combined representation by combining the set of weight representations with the set of feature representations; and a determination module on the basis of the combined representation configured to determine the second set of weights based on the combined representation.

In some embodiments, the determination module on the basis of the combined representation includes: a combined representation modification module configured to generate a modified combined representation by modifying the combined representation; and a combined representation weight determination module configured to determine the second set of weights based on the modified combined representation.

In some embodiments, the combined representation modification module includes: a component determination module configured to determine a plurality of components of each representation in the combined representation; a module for determining at least one configured to, for each representation, determine at least one of: a maximum value and a minimum value among the plurality of components or an average value of the plurality of components; and a module for generating a modified combined representation configured to generate the modified combined representation based on the determined at least one.

In some embodiments, the combined representation modification module includes: a neural network modification module configured to generate the modified combined representation by applying the neural network model to the combined representation.

In some embodiments, the combined representation modification module includes: a first set module configured to group representations in the combined representation to generate a plurality of groups of representations; a statistic value determination module configured to determine statistic values for each representation in the plurality of groups of representations; and a generation module on the basis of statistic values configured to generate the modified combined representation with the statistic values.

In some embodiments, the combined representation weight determination module includes: a compression module configured to compress the modified combined representation to generate the compressed combined representation; and a modification module on the basis of the compressed combined representation configured to modify the compressed combined representation to generate the second set of weights.

In some embodiments, the recommendation module includes: a weight application module configured to apply the second set of weights to the combined representation to generate the weighted combined representation; a updated combined representation generation module configured to combine the weighted combined representation with the combined representation to generate an updated combined representation; and an information recommendation module configured to recommend information to the user based on the updated combined representation.

In some embodiments, the information recommendation module includes: a updated combined representation modification module configured to obtain a updated combined representation modified by modifying the updated combined representation; a third set of weights determination module configured to determine a third set of weights for the updated combined representation based on the updated combined representation modified; and a module for generating updated combined representation weighted configured to generate a updated combined representation weighted based on the updated combined representation and the third set of weights, wherein a manner for modifying the updated combined representation is different from a manner for modifying the combined representation.

In some embodiments, determination of the second set of weights, generation of the combined representation weighted and combination of the combined representation weighted and the combined representation are implemented by a neural network model. The apparatus 600 also includes: a training module configured to train the neural network model based on a set of sample feature representations of a plurality of features corresponding to sample information recommendation and a sample result of the sample information selected by users.

FIG. 7 illustrates a schematic block diagram of an example device 700 for implementing embodiments of the present disclosure. The computing device 110 in FIG. 1 may be implemented by the device. As shown in FIG. 7, the device 700 comprises a central process unit (CPU) 701, which can execute various suitable actions and processing based on the computer program instructions stored in a read-only memory (ROM) 702 or computer program instructions loaded in the random-access memory (RAM) 703 from a storage unit 708. The RAM 703 can also store all kinds of programs and data required by the operation of the device 700. CPU 701, ROM 702 and RAM 703 are connected to each other via a bus 704. The input/output (I/O) interface 705 is also connected to the bus 704.

A plurality of components in the device 700 is connected to the I/O interface 705, including: an input unit 706, such as a keyboard, a mouse and the like; an output unit 707, e.g., various kinds of display and loudspeakers etc.; a storage unit 708, such as a disk and an optical disk etc.; and a communication unit 709, such as a network card, a modem, a wireless transceiver and the like. The communication unit 709 allows the device 700 to exchange information/data with other devices via the computer network, such as Internet, and/or various telecommunication networks.

The above described procedure and processing, such as method 300, can be executed by the processing unit 701. For example, in some embodiments, the method 300 can be implemented as a computer software program tangibly included in the machine-readable medium, e.g., storage unit 708. In some embodiments, the computer program can be partially or fully loaded and/or mounted to the device 700 via ROM 702 and/or communication unit 709. When the computer program is loaded to RAM 703 and executed by the CPU 701, one or more actions of the above describe method 300 can be implemented.

The present disclosure can be a method, apparatus, system and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, such as an electrical storage device, a magnetic storage device, an optical storage device, an electromagnetic storage device, a semiconductor storage device or any appropriate combinations of the above. More concrete examples of the computer-readable storage medium (non-exhaustive list) include: a portable computer disk, a hard disk, a random-access memory (RAM), a read-only memory (ROM), an erasable programmable read-only memory (EPROM or flash), a static random-access memory (SRAM), a portable compact disk read-only memory (CD-ROM), a digital versatile disk (DVD), a memory stick, a floppy disk, mechanical coding devices, a punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can comprise copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages comprise object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow chart and/or block diagram of method, apparatus (system) and computer program products according to embodiments of the present disclosure. It should be understood that each block of the flow chart and/or block diagram and the combination of various blocks in the flow chart and/or block diagram can be implemented by computer-readable program instructions.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions comprises an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by system, method and computer program product according to multiple implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various embodiments of the present disclosure have been described above and the above description is only exemplary rather than exhaustive and is not limited to the embodiments of the present disclosure. Many modifications and alterations, without deviating from the scope and spirit of the explained various embodiments, are obvious for those skilled in the art. The selection of terms in the text aims to best explain principles and actual applications of each embodiment and technical improvements made in the market by each embodiment, or enable those ordinary skilled in the art to understand embodiments of the present disclosure.

I/We claim:

1. A method of recommending information, comprising:
determining, based on a set of feature representations of a plurality of features associated with information recommendation, a first set of weights indicating importance of the plurality of features;
determining a second set of weights based on the set of feature representations and the first set of weights; and
recommending the information to a user based on the set of feature representations, the first set of weights and the second set of weights.

2. The method according to claim 1, wherein determining the first set of weights comprises:
obtaining the first set of weights by applying a logistic regression model to the set of feature representations.

3. The method according to claim 1, wherein the plurality of features includes at least one of: a user identification, user behavior statistics, an information identification, information attributes, traffic attributes and device attributes.

4. The method according to claim 1, wherein determining the second set of weights comprises:
generating a set of weight representations by dividing the first set of weights into a plurality of subsets, each subset forming a weight representation;
generating a combined representation by combining the set of weight representations with the set of feature representations; and
determining the second set of weights based on the combined representation.

5. The method according to claim 4, wherein determining the second set of weights based on the combined representation comprises:
modifying the combined representation to generate the modified combined representation; and
determining the second set of weights based on the modified combined representation.

6. The method according to claim 5, wherein modifying the combined representation comprises:
determining a plurality of components of each representation in the combined representation;
for each representation, determining at least one of: a maximum value or a minimum value among the plurality of components or an average value of the plurality of components; and
generating the modified combined representation based on the determined at least one.

7. The method according to claim 5, wherein modifying the combined representation comprises:
generating the modified combined representation by applying a neural network model to the combined representation.

8. The method according to claim 5, wherein modifying the combined representation comprises:
grouping representations in the combined representation to generate a plurality of groups of representations;
determining statistic values for each of the plurality of groups of representations; and
generating the modified combined representation with the statistic values.

9. The method according to claim 5, wherein determining the second set of weights based on the modified combined representation comprises:
compressing the modified combined representation to generate the compressed combined representation; and
modifying the compressed combined representation to generate the second set of weights.

10. The method according to claim 4, wherein recommending the information to a user comprises:
applying the second set of weights to the combined representation to generate the weighted combined representation;
combining the weighted combined representation with the combined representation to generate an updated combined representation; and
recommending the information to the user based on the updated combined representation.

11. The method according to claim 10, wherein recommending the information to the user based on the updated combined representation comprises:
obtaining the updated combined representation modified by modifying the updated combined representation;
determining, based on the updated combined representation modified, a third set of weights for the updated combined representation; and
generating the updated combined representation weighted based on the updated combined representation and the third set of weights; and
wherein a manner for modifying the updated combined representation is different from a manner for modifying the combined representation.

12. The method according to claim 10, wherein determination of the second set of weights, generation of the weighted combined representation and combination of the weighted combined representation and the combined representation are implemented by a neural network model, and the method further comprises:
training the neural network model based on a set of sample feature representations of a plurality of features corresponding to sample information recommendation and a sample result of sample information selected by users.

13. An electronic device, comprising:
at least one processor; and
a storage device for storing at least one program which, when executed by the at least one processor, causes the at least one processor to perform operations comprising:
determining, based on a set of feature representations of a plurality of features associated with information recommendation, a first set of weights indicating importance of the plurality of features;
determining a second set of weights based on the set of feature representations and the first set of weights; and
recommending the information to a user based on the set of feature representations, the first set of weights and the second set of weights.

14. The electronic device according to claim 13, wherein determining the first set of weights comprises:
obtaining the first set of weights by applying a logistic regression model to the set of feature representations.

15. The electronic device according to claim 13, wherein the plurality of features includes at least one of: a user identification, user behavior statistics, an information identification, information attributes, traffic attributes and device attributes.

16. The electronic device according to claim 13, wherein determining the second set of weights comprises:
generating a set of weight representations by dividing the first set of weights into a plurality of subsets, each subset forming a weight representation;
generating a combined representation by combining the set of weight representations with the set of feature representations; and
determining the second set of weights based on the combined representation.

17. The electronic device according to claim 16, wherein determining the second set of weights based on the combined representation comprises:
modifying the combined representation to generate the modified combined representation; and
determining the second set of weights based on the modified combined representation.

18. The electronic device according to claim 17, wherein modifying the combined representation comprises:
determining a plurality of components of each representation in the combined representation;
for each representation, determining at least one of: a maximum value or a minimum value among the plurality of components or an average value of the plurality of components; and
generating the modified combined representation based on the determined at least one.

19. The electronic device according to claim 17, wherein modifying the combined representation comprises:
generating the modified combined representation by applying a neural network model to the combined representation.

20. A computer-readable storage medium having computer programs stored thereon which, when executed by a processor, cause the processor to perform operations comprising:
determining, based on a set of feature representations of a plurality of features associated with information recommendation, a first set of weights indicating importance of the plurality of features;
determining a second set of weights based on the set of feature representations and the first set of weights; and
recommending the information to a user based on the set of feature representations, the first set of weights and the second set of weights.
